(19) United States
(12) Patent Application Publication
(10) Pub. No.: US 2023/0253150 A1
(43) Pub. Date: Aug. 10, 2023

(54) MANUFACTURING METHOD OF INDUCTOR AND MANUFACTURING METHOD OF ELECTRONIC COMPONENT

(71) Applicant: FUJIFILM Corporation, Tokyo (JP)

(72) Inventor: Tatsuo MIKAMI, Minamiashigara-shi (JP)

(73) Assignee: FUJIFILM Corporation, Tokyo (JP)

(21) Appl. No.: 18/187,116

(22) Filed: Mar. 21, 2023

Related U.S. Application Data
(63) Continuation of application No. PCT/JP2021/034154, filed on Sep. 16, 2021.

(30) Foreign Application Priority Data
Sep. 30, 2020 (JP) 2020-165828

(51) Int. Cl. H01F 41/04; H01F 17/00

(52) U.S. Cl. CPC H01F 41/046; H01F 17/0013; H01F 2017/0066; H01F 2017/0073

(57) ABSTRACT

Provided are a manufacturing method of an inductor, including forming a first magnetic layer and forming a discontinuous layer of one of a second magnetic layer and a conductive layer on the first magnetic layer, and forming the other in a discontinuous portion of the discontinuous layer, in which a thickness of the second magnetic layer is larger than a thickness of the conductive layer, and the manufacturing method further includes forming a third magnetic layer in a groove portion formed by a difference in thickness between the second magnetic layer and the conductive layer; and a manufacturing method of an electronic component including an inductor, the manufacturing method including producing an inductor by the manufacturing method.

### CROSS-REFERENCE TO RELATED APPLICATIONS

This application is a Continuation of PCT International Application No. PCT/JP2021/034154 filed on Sep. 16, 2021, which claims priority under 35 U.S.C. §119(a) to Japanese Patent Application No. 2020-165828 filed on Sep. 30, 2020. Each of the above applications is hereby expressly incorporated by reference, in its entirety, into the present application.

### BACKGROUND OF THE INVENTION

### 1. Field of the Invention

The present invention relates to a manufacturing method of an inductor and a manufacturing method of an electronic component.

### 2. Description of the Related Art

An inductor is a passive electronic element included in various electronic components. As a manufacturing method of an electronic circuit which includes the electronic component including the inductor, a method of mounting the electronic component as a discrete component on a printed substrate has been used in the related art. On the other hand, in recent years, in order to further increase integration density, it has been studied to produce a component-embedded substrate in which electronic components are mounted in a multilayer substrate. In addition, for the purpose of production in small amount for various kinds, applications for a flexible device, and the like, a method of producing the electronic component by printing, that is, so-called printed electronics have been studied. In these production methods, a planar structure is suitable for the structure of the electronic component, so that a planar inductor such as a spiral inductor is generally used as the inductor.

With regard to the inductor of the electronic component, inductance is usually improved by combining a coil with a magnetic material. However, for the planar inductor in the component-embedded substrate and the printed electronics, manufacturing process and the like have not yet been sufficiently studied, and an air-core inductor which is composed of only coils and does not include the magnetic material has been generally used. On the other hand, in recent years, it has been studied to produce a planar inductor by combining a conductive layer and a magnetic layer (see JP2015-50290A).

### SUMMARY OF THE INVENTION

As compared with the air-core inductor which is composed of only coils and does not include the magnetic material, the inductor in which the conductive layer and the magnetic layer are combined tends to exhibit higher inductance. In a case where the inductance of such an inductor can be further improved, it leads to improved performance of the electronic component and the electronic circuit, which is desirable.

An aspect of the present invention is to provide a method capable of manufacturing an inductor in which a conductive layer and a magnetic layer are combined and which can exhibit high inductance.

One aspect of the present invention relates to a manufacturing method of an inductor, including:
forming a first magnetic layer; and
forming a discontinuous layer of one of a second magnetic layer and a conductive layer on the first magnetic layer, and forming the other in a discontinuous portion of the discontinuous layer,
in which a thickness of the second magnetic layer is larger than a thickness of the conductive layer, and
the manufacturing method further includes forming a third magnetic layer in a groove portion formed by a difference in thickness between the second magnetic layer and the conductive layer.

In one aspect, it is possible that, in the forming a discontinuous layer of one of a second magnetic layer and a conductive layer on the first magnetic layer, and forming the other in a discontinuous portion of the discontinuous layer, the discontinuous layer of the second magnetic layer is formed on the first magnetic layer, and the conductive layer is formed in a discontinuous portion of the discontinuous layer of the second magnetic layer.

In one aspect, it is possible that the discontinuous layer has a spiral pattern.

In one aspect, it is possible that the forming of the second magnetic layer and the forming of the third magnetic layer are performed by applying a composition containing magnetic particles.

In one aspect, it is possible that the applying of the composition containing magnetic particles is performed by applying the composition containing magnetic particles with a dispenser.

In one aspect, it is possible that the composition containing magnetic particles is a magnetic resin composition containing the magnetic particles and a resin.

In one aspect, it is possible that the magnetic particles include metal particles.

In one aspect, it is possible that the metal particles include Ni and Fe.

In one aspect, it is possible that the metal particles further include Mo.

In one aspect, it is possible that the forming of the conductive layer is performed by applying a conductive composition.

In one aspect, it is possible that the applying of the conductive composition is performed by applying the conductive composition with a dispenser.

One aspect of the present invention relates to a manufacturing method of an electronic component including an inductor, the manufacturing method including producing an inductor by the manufacturing method described above.

According to one aspect of the present invention, it is possible to provide a manufacturing method capable of manufacturing an inductor in which a conductive layer and a magnetic layer are combined and which has excellent inductance. In addition, according to one aspect of the present invention, it is possible to provide a manufacturing method of an electronic component including an inductor, which includes producing an inductor by the manufacturing method.

### BRIEF DESCRIPTION OF THE DRAWINGS

FIG. 1A is an explanatory diagram of an example of a manufacturing process of an inductor.

FIG. 1B is an explanatory diagram of an example of a manufacturing process of an inductor.

FIG. 1C is an explanatory diagram of an example of a manufacturing process of an inductor.

FIG. 1D is an explanatory diagram of an example of a manufacturing process of an inductor.

### DESCRIPTION OF THE PREFERRED EMBODIMENTS

### Manufacturing Method of Inductor

One embodiment of the present invention relates to a manufacturing method of an inductor. The manufacturing method of an inductor includes forming a first magnetic layer and forming a discontinuous layer of one of a second magnetic layer and a conductive layer on the first magnetic layer, and forming the other in a discontinuous portion of the discontinuous layer, in which a thickness of the second magnetic layer is larger than a thickness of the conductive layer, and the manufacturing method further includes forming a third magnetic layer in a groove portion formed by a difference in thickness between the second magnetic layer and the conductive layer.

The inductor manufactured by the above-described manufacturing method of an inductor can be generally called a planar inductor, a plan-type inductor, or the like. In such an inductor, since upper and lower surfaces and side surfaces of the conductive layer are covered with the first magnetic layer, the second magnetic layer, and the third magnetic layer, the inductor can exhibit higher inductance than an air-core inductor.

In the present invention and the present specification, the “magnetic” means ferromagnetic property, the “conductive” means a property of conducting electricity, and specifically means that a volume resistivity is 1 × 10⁻¹ Ω·m or less.

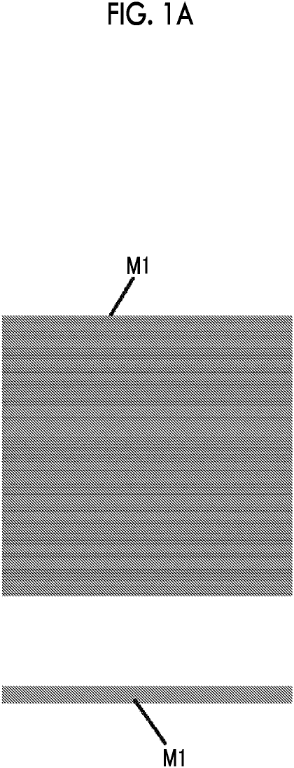

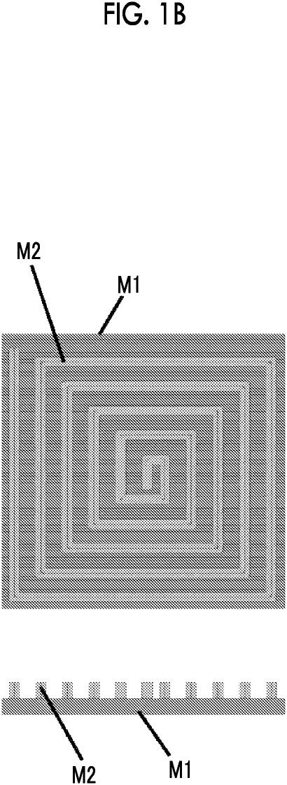

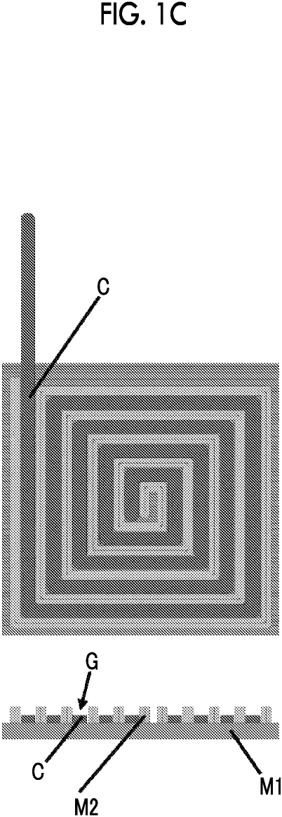

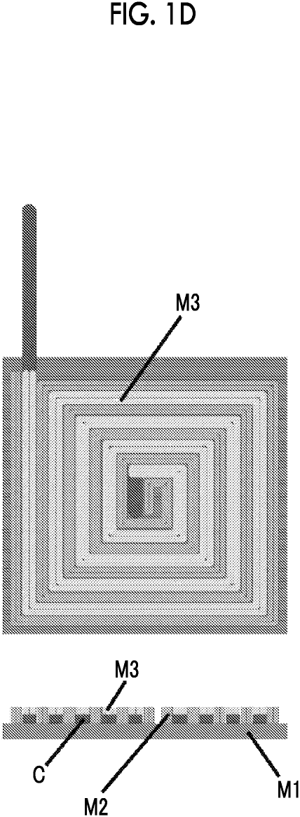

In the present invention and the present specification, the “discontinuous layer” means a layer including a discontinuous portion, that is, a gap in the layer in a plan view. On the other hand, a “continuous layer” means a layer which does not include the discontinuous portion, that is, the gap in the layer in a plan view. The discontinuous layer can have, for example, a spiral pattern. With regard to the spiral pattern, the shape of the spiral is not particularly limited, and examples thereof include a shape shown in FIGS. 1A to 1D described later. For example, as shown in FIGS. 1A to 1D, the discontinuous layer can be formed as a continuous band-like pattern from one end part to the other end part of the spiral.

FIGS. 1A to 1D are explanatory diagrams of examples of a manufacturing process of an inductor. In each figure, the upper diagram is a plan view, and the lower diagram is a cross-sectional view. FIG. 1A to FIG. 1D are also collectively referred to as “FIGS. 1A to 1D”. Hereinafter, the above-described manufacturing method of an inductor will be described in more detail with reference to FIGS. 1A to 1D. However, the embodiments shown in the figures are exemplary, and the present invention is not limited to the exemplary embodiments.

### Forming of First Magnetic Layer

The first magnetic layer can be formed, for example, as a continuous layer on a substrate (not shown) (in FIG. 1A, a first magnetic layer M1). As the substrate, a substrate which can be normally used as a substrate of the planar inductor can be used. Specific examples of such a substrate include various substrates such as a resin substrate, a metal substrate, a glass epoxy substrate, and a silicon substrate. Examples of the resin substrate include films of various resins such as polyesters such as polyethylene terephthalate (PET) and polyethylene naphthalate (PEN), polycarbonate (PC), acrylics such as polymethylmethacrylate (PMMA), cyclic polyolefins, triacetyl cellulose (TAC), polytetrafluoroethylene (PTFE), polyether sulfide (PES), polyether ketone, and polyimide. With regard to these resin films, paragraphs 0081 to 0086 of JP2015-187260A can be referred to. In addition, with regard to the substrate, paragraphs 0102 to 0104 of JP2015-187260A can also be referred to. As the substrate, an insulating substrate is preferable. Here, the “insulating” means a property which does not correspond to the above-described conductivity. A thickness of the substrate can be, for example, in a range of 5 to 2000 µm. However, the thickness of the substrate may be determined according to the application of the inductor, and is not limited to the above-described range.

The first magnetic layer can be formed, for example, by applying a composition containing magnetic particles onto the substrate by, for example, directly applying the composition to a surface of the substrate. The applying can be performed by a coating method selected from various coating methods such as a coating method using a dispenser (hereinafter, referred to as a “dispense method”), a screen printing method, an ink jet printing method, and a spin coating method. The composition for producing the first magnetic layer will be described later.

In a case where the composition for forming the first magnetic layer is a curable composition, after the applying, the curable composition is cured by subjecting the curable composition to a curing treatment such as heat treatment and light irradiation depending on the type of the composition, so that the first magnetic layer as a cured layer can be formed. In the present invention and the present specification, the “cured layer” includes a layer of a cured product in which progress of a curing reaction of a curable component contained in the curable composition is saturated or nearly saturated, and a layer of a partially cured product in which only a part of the curing reaction is progressed.

A thickness of the first magnetic layer can be, for example, in a range of 5 to 2000 µm. However, the thickness of the first magnetic layer may be determined according to the application of the inductor, and the like, and is not limited to the above-described range.

### Forming of Second Magnetic Layer and Conductive Layer

After the forming of the first magnetic layer, a discontinuous layer of one of a second magnetic layer and a conductive layer is formed on the first magnetic layer, the other layer is formed in a discontinuous portion of the discontinuous layer. In one embodiment, the discontinuous layer of the second magnetic layer is formed on the first magnetic layer, and the conductive layer is formed in a discontinuous portion of the second magnetic layer. In another embodiment, the discontinuous layer of the conductive layer is formed on the first magnetic layer, and the second magnetic layer is formed in a discontinuous portion of the discontinuous layer of the conductive layer. FIGS. 1A to 1D show a manufacturing process of the former embodiment. From the viewpoint of ease of forming a conductive layer having excellent thickness uniformity, the former embodiment is preferable, that is, it is preferable that the discontinuous layer of the second magnetic layer is formed on the first magnetic layer, and the conductive layer is formed in a discontinuous portion of the second magnetic layer. The fact that the conductive layer having excellent thickness uniformity can be formed is preferable from the viewpoint of reducing variation in inductance between electronic components.

The second magnetic layer can be formed, for example, as a discontinuous layer by applying the composition containing magnetic particles directly to a surface of the first magnetic layer in a patterned manner (in FIG. 1B, a second magnetic layer M2). The applying can be performed by a coating method selected from various coating methods such as a coating method using a dispenser (dispense method), a screen printing method, an ink jet printing method, and a spin coating method. Among these, from the viewpoint of ease of forming a pattern having excellent shape uniformity, the dispense method is preferable as a coating method for forming the discontinuous layer, compared to the printing method described above. In addition, since the composition can be easily applied to a target position in a patterned manner, from the viewpoint of productivity, the dispense method is preferable compared to the spin coating method. Alternatively, a patterned second magnetic layer (discontinuous layer) can also be formed by forming the second magnetic layer as a continuous layer and then removing unnecessary portions. The unnecessary portions can be removed by a known patterning method.

In a case where the composition for forming the second magnetic layer is a curable composition, after the applying, the curable composition is cured by subjecting the curable composition to a curing treatment such as heat treatment and light irradiation depending on the type of the composition, so that the second magnetic layer as a cured layer can be formed. The curing treatment can be performed before the forming of the conductive layer, can be performed after the forming of the conductive layer, or can be performed before and after the forming of the conductive layer. The composition for producing the second magnetic layer will be described later.

In a case where the second magnetic layer is formed on the first magnetic layer as a discontinuous layer, the conductive layer is formed in a discontinuous portion, that is, a gap of this discontinuous layer (in FIG. 1C, a conductive layer C). The conductive layer formed as above is also a discontinuous layer, and the second magnetic layer is disposed in a discontinuous portion of this discontinuous layer. For example, in a case where the discontinuous layer of the second magnetic layer is formed as a spiral pattern, since the discontinuous portion of the spiral pattern is also spiral, by forming the conductive layer to fill this discontinuous portion, the conductive layer can be disposed in a spiral pattern. However, since the conductive layer formed here is thinner than the second magnetic layer, a groove portion is formed by a difference in thickness between two layers. In addition, by causing an outer end part of the spiral of the pattern of the conductive layer to protrude above the first magnetic layer, the protruding portion can be used as a contact point of the inductor.

On the other hand, in a case where the conductive layer is formed on the first magnetic layer as a discontinuous layer, the second magnetic layer is formed in a discontinuous portion, that is, a gap of this discontinuous layer. The second magnetic layer formed as above is also a discontinuous layer, and the conductive layer is disposed in a discontinuous portion of this discontinuous layer. For example, in a case where the discontinuous layer of the conductive layer is formed as a spiral pattern, since the discontinuous portion of the spiral pattern is also spiral, by forming the second magnetic layer to fill this discontinuous portion, the second magnetic layer can be disposed in a spiral pattern. However, since the second magnetic layer formed here is thicker than the conductive layer, a groove portion is formed by a difference in thickness between two layers.

Examples of a method for forming the conductive layer include a method of applying a conductive composition in a patterned manner; a method in which a continuous layer of the conductive layer is formed by a film forming method such as sputtering and vapor deposition, and then unnecessary portions are removed to form a patterned conductive layer (discontinuous layer); a method in which a metal salt is electrically deposited in an aqueous solution containing the metal salt to form a continuous layer of the conductive layer, and then unnecessary portions are removed to form a patterned conductive layer (discontinuous layer); and a method of attaching a conductor wire. With regard to the applying, examples of a coating method include coating methods such as a coating method using a dispenser (dispense method), a screen printing method, an ink jet printing method, and a spin coating method. For the reasons described above, the dispense method is preferable. The conductive composition will be described later.

A width of the spiral pattern of the second magnetic layer can be, for example, in a range of 10 to 5000 µm. A width of the spiral pattern of the conductive layer can be, for example, in a range of 10 to 5000 µm. However, the width of the pattern may be determined according to the application of the inductor, and the like, and is not limited to the above-described range. In addition, the width of the pattern can be measured by a known measuring device having a contact-type or non-contact-type length measuring function, and for example, an arithmetic mean of measured values at 20 randomly selected locations in the spiral pattern can be adopted as the width of the pattern. Alternatively, the width of the pattern can also be obtained as a design width calculated from the manufacturing conditions.

In the above-described manufacturing method of an inductor, in either the embodiment in which the second magnetic layer is first formed as a discontinuous layer on the first magnetic layer or the embodiment in which the conductive layer is first formed as a discontinuous layer on the first magnetic layer, the thickness of the second magnetic layer is larger than the thickness of the conductive layer. As a result, a groove portion is formed by the difference in thickness between the second magnetic layer and the conductive layer (in FIG. 1C, a groove portion G).

With regard to the difference in thickness between the second magnetic layer and the conductive layer, from the viewpoint of ease of forming the third magnetic layer, which will be described later, a difference in thickness between the two layers “(Thickness of second magnetic layer) - (Thickness of conductive layer)” is preferably 10 µm or more, more preferably 20 µm or more, and still more preferably 50 µm or more. In addition, from the same viewpoint, the above-described difference in thickness between the two layers is preferably 1500 µm or less, more preferably 1300 µm or less, and still more preferably 1000 µm or less. A depth of the groove portion, which will be described later, has the same value as the above-described difference in thickness between the two layers.

The thickness of the second magnetic layer can be, for example, in a range of 5 to 2000 µm. The thickness of the conductive layer can be, for example, in a range of 5 to 2000 µm. However, the thickness of the second magnetic layer and the thickness of the conductive layer may be determined according to the application of the inductor, and the like, and are not limited to the above-described range.

The various thicknesses can be measured by a known contact-type or non-contact-type film thickness measuring unit. As the thickness value, for example, an arithmetic mean of thicknesses measured at 20 randomly selected locations can be adopted. Alternatively, the various thicknesses can also be obtained as a design thickness calculated from the manufacturing conditions.

### Forming of Third Magnetic Layer

After the second magnetic layer and the conductive layer are formed as described above, the third magnetic layer is formed in the groove portion formed by the difference in thickness between the second magnetic layer and the conductive layer. As the forming of the third magnetic layer in this way, the present inventor has considered as follows.

The fact that the variation in thickness of the inductor is small can contribute to the fact that the inductor exhibits high inductance. This is because that the measurement of the inductance is performed based on a portion where the thickness of the inductor is the thickest, so that in a case where the variation in thickness is large, as compared with a case where the variation in thickness is small, a proportion of the magnetic layer to a volume of the inductor is smaller. Regarding this point, JP2015-50290A described above discloses, as Example 1, a manufacturing method of an inductor, in which a magnetic layer is formed to collectively cover upper and side surfaces of a conductive pattern (see paragraph 0022 and FIG. 2 of JP2015-50290A). However, in a case where the magnetic layer is provided as in such a manufacturing method, the variation in thickness of the magnetic layer is large, and as a result, the variation in thickness of the inductor is large. It is presumed that this is because, in the magnetic layers provided together, a height of a portion where the conductive pattern is present in the lower layer is likely to be higher than a height of a portion where the conductive pattern is not present in the lower layer. In addition, in a case where the magnetic layer is formed to collectively cover upper and side surfaces of the conductive pattern as in Example 1 of JP2015-50290A, the composition for forming the second magnetic layer tends to be insufficiently filled around the conductive pattern, and as a result, it is considered that voids are likely to occur in the magnetic layer. The presence of such voids can also lead to a decrease in inductance. On the other hand, the present inventor has presumed that the aspect in which the second magnetic layer and the conductive layer are formed as described above, and then the third magnetic layer is formed in the groove portion formed by the difference in thickness of the two layers leads to suppressing the occurrence of such variation in thickness, and also leads to suppressing the occurrence of voids. As a result, the present inventor has considered that, with the above-described manufacturing method of an inductor, it is possible to manufacture an inductor which can exhibit high inductance.

In Example 2 of JP2015-50290A, after a magnetic layer is formed by embedding a composite material in gaps of a conductive pattern, a planarization treatment is performed so that the conductive pattern and the magnetic layer have the same thickness (see paragraph 0040 of JP2015-50290A). On the other hand, by forming the magnetic layer (third magnetic layer) in the groove portion as described above, it is possible to manufacture the inductor having a small variation in thickness without performing such a planarization treatment. This is preferable from the viewpoint of simplifying the manufacturing process.

The third magnetic layer is formed in the groove portion (in FIG. 1C, the groove portion G) by the difference in thickness between the second magnetic layer and the conductive layer. In this way, the third magnetic layer can be formed as a discontinuous layer which covers the upper surface of the conductive layer. For example, the third magnetic layer can be formed by applying a composition containing magnetic particles to fill the groove portion (in FIG. 1D, a third magnetic layer M3). In this way, the third magnetic layer is laminated on the conductive layer in the groove portion. Here, it is allowed that a part of the composition applied to the groove portion is applied onto the second magnetic layer outside the groove portion. The discontinuous layer of the third magnetic layer can also have a spiral pattern, and a width of this spiral pattern can be, for example, in a range of 10 to 5000 µm. In addition, by not laminating the third magnetic layer on a part of the conductive layer, for example, by not laminating the third magnetic layer over an inner end part of the spiral of the spiral pattern of the conductive layer, the exposed portion where the third magnetic layer is not laminated can be used as a contact point of the inductor.

By forming the third magnetic layer in the groove portion as described above, the upper and lower surfaces and the side surfaces of the conductive layer can be covered with the first magnetic layer, the second magnetic layer, and the third magnetic layer. In a case where a surface on the first magnetic layer side is referred to as a lower surface and the other surface is referred to as an upper surface, according to the above-described manufacturing method of an inductor, it is possible to manufacture an inductor having a small variation in height of the upper surface. This leads to reduction of variation in thickness of the inductor, and as a result, can contribute to provide an inductor which can exhibit high inductance.

Regarding the forming of the third magnetic layer, for example, the third magnetic layer can be formed as a discontinuous layer by applying a composition containing magnetic particles to fill the groove portion formed by the difference in thickness between the second magnetic layer and the conductive layer (in FIG. 1D, a third magnetic layer M3). The applying can be performed by a coating method selected from various coating methods such as a coating method using a dispenser (dispense method), a screen printing method, an inkjet printing method, and a spin coating method. For the reasons described above, the dispense method is a preferred coating method.

In a case where the composition for forming the third magnetic layer is a curable composition, after the applying, the curable composition is cured by subjecting the curable composition to a curing treatment such as heat treatment and light irradiation depending on the type of the composition, so that the third magnetic layer as a cured layer can be formed. The composition for producing the third magnetic layer will be described later.

The third magnetic layer is formed in the above-described groove portion. A thickness of the third magnetic layer can be the same value as a depth of the groove portion, and the depth of the groove portion is as described above.

### Composition for Forming Magnetic Layer

In a case where the composition used for forming a magnetic layer is referred to as a “composition for forming a magnetic layer”, the compositions for forming a magnetic layer, which are used for forming the first magnetic layer, the second magnetic layer, and the third magnetic layer, may be the same or different from each other.

### Magnetic Particles

The first magnetic layer, the second magnetic layer, and the third magnetic layer can be formed of a composition containing magnetic particles. As the above-described magnetic particles, one kind selected from the group consisting of magnetic particles generally referred to as soft magnetic particles, such as metal particles and ferrite particles, can be used, or two or more kinds thereof can be used in combination.

### Metal Particles

In the present invention and the present specification, the “metal particles” include pure metal particles consisting of a single metal element and particles of an alloy of one or more kinds of metal elements and one or two or more kinds of other metal elements and/or non-metal elements. The metal particles may or may not be crystalline. That is, the metal particles may be crystalline particles or amorphous particles. Examples of the metal or non-metal element included in the metal particles include Ni, Fe, Co, Mo, Cr, Si, B, and P. The metal particles may or may not include a component other than the constituent elements of the metal (including the alloy). In addition to the constituent elements of the metal (including the alloy), the metal particles may include, at any content, elements included in the additive which may be optionally added and/or elements included in impurities which may be unintentionally mixed in the manufacturing process of the metal particles. In the metal particles, a content of the constituent elements of the metal (including the alloy) is preferably 90.0% by mass or more and more preferably 95.0% by mass or more, and may be 100% by mass, less than 100% by mass, 99.9% by mass or less, or 99.0% by mass or less.

In one embodiment, the metal particles can include Ni and Fe, and can further include Mo. For example, with regard to the member of the electronic component, the fact that a decrease in magnetic permeability µr′ in an acidic environment is suppressed is preferable from the viewpoint of providing a member in which performance is less deteriorated in a case of being used for a long period of time and/or in a case of being placed in a harsh environment. From the viewpoint of suppressing such a decrease in magnetic permeability µr′, magnetic particles in which oxidation is unlikely to proceed in the acidic environment are preferable. From this point of view, metal particles including Ni and Fe are preferable, and metal particles including Ni, Fe, and Mo are more preferable. From the viewpoint of further suppressing the progress of oxidation in the acidic environment, in the metal particles including Ni and Fe or further including Mo as the metal particles, the total content of Ni, Fe, and Mo is preferably 90.0% by mass or more and more preferably 95.0% by mass or more, and may be 100% by mass, less than 100% by mass, 99.9% by mass or less, or 99.0% by mass or less. A content of Ni is preferably 20.0% by mass or more and more preferably 30.0% by mass or more, and preferably 90.0% by mass or less and more preferably 80.0% by mass or less. A content of Mo is preferably 0.5% by mass or more and more preferably 2.0% by mass or more, and preferably 20.0% by mass or less and more preferably 10.0% by mass or less.

An average particle size of the metal particles can be, for example, 40.0 µm or less, 38.0 µm or less, 36.0 µm or less, 34.0 µm or less, 32.0 µm or less, 30.0 µm or less, or less than 30.0 µm. With regard to physical properties of the member included in the electronic component, from the viewpoint of reducing loss of the electronic component, it is desirable that a loss tangent tan δ is small at an operating frequency of the electronic component. The loss tangent tan δ is calculated by tan δ = µr″ /µr′ from a real part µr′ of a complex magnetic permeability and an imaginary part µr″ of the complex magnetic permeability. As the metal particles, from the viewpoint of making it possible to manufacture a member with a small loss tangent tan δ in a high frequency band (for example, approximately 10 MHz), metal particles having an average particle size of less than 30.0 µm are preferable, metal particles having an average particle size of 28.0 µm or less are more preferable, metal particles having an average particle size of 26.0 µm or less are still more preferable, metal particles having an average particle size of 24.0 µm or less are even more preferable, and metal particles having an average particle size of 23.0 µm or less are even still more preferable. In addition, the average particle size of the metal particles can be, for example, 1.0 µm or more, 1.5 µm or more, 2 µm or more, or more than 2.5 µm. From the viewpoint of further increasing the magnetic permeability, the average particle size of the metal particles is preferably more than 2.7 µm, more preferably 2.9 µm or more, and still more preferably 3 µm or more.

In the present invention and the present specification, unless otherwise specified, average particle sizes of various particles are values measured by the following method using a scanning electron microscope.

The particles are captured using a transmission electron microscope at a capturing magnification of 3000 to obtain an image of the particles. A target particle is selected from the obtained image, an outline of the particle is traced by a digitizer, and a size of the particle (primary particle) is measured. The primary particle refers to an independent particle without being aggregated.

The measurement described above is performed on 500 particles randomly extracted. An arithmetic mean of the particle sizes of the 500 particles thus obtained is defined as an average particle size of the particles. As the above-described scanning electron microscope, for example, a field emission-scanning electron microscope (FE-SEM) S4800 manufactured by Hitachi, Ltd. can be used. In addition, the measurement of the particle size can be performed by known image analysis software, for example, image analysis software KS-400 manufactured by Carl Zeiss. The average particle size shown in Examples is a value obtained using FE-SEM S4800 manufactured by Hitachi, Ltd. as a scanning electron microscope (FE-SEM), and image analysis software KS-400 manufactured by Carl Zeiss as image analysis software.

In the present invention and the present specification, unless otherwise specified, a size of the primary particle of the particles is represented by,
(1) in a case where the shape of the particles observed in the above-described particle image is needle-like, spindle-like, columnar (however, the height is greater than the maximum major diameter of the bottom surface), or the like, the length of the major axis constituting the particles, that is, a major axis length;
(2) in a case where the shape of the particles observed in the above-described particle image is plate-like or columnar (however, the thickness or the height is smaller than the maximum major diameter of the plate surface or the bottom surface), the maximum major diameter of the plate surface or bottom surface; and
(3) in a case where the shape of the particles observed in the above-described particle image is spherical, polyhedral, amorphous, or the like, in which the major axis constituting the particles cannot be identified from the shape, the equivalent circle diameter which is obtained by a circular projection method.

The average particle size of the magnetic particles included in the composition can be obtained, for example, by performing the above-described measurement on the magnetic particles used for producing the composition or on the magnetic particles of the same lot as the magnetic particles. In addition, for example, by extracting the magnetic particles from the composition or from the magnetic layer formed of the composition by a known method and performing the above-described measurement on the extracted magnetic particles, the average particle size of the magnetic particles can be obtained.

### Ferrite Particles

As the above-described magnetic particles, ferrite particles can also be used, and a combination of metal particles and ferrite particles can also be used. A content of the ferrite particles is preferably 1 part by mass or more, more preferably 2 parts by mass or more, and still more preferably 3 parts by mass or more with respect to 100 parts by mass of the metal particles. In addition, the content of the ferrite particles can be, for example, 20 parts by mass or less, 15 parts by mass or less, or 10 parts by mass or less with respect to 100 parts by mass of the metal particles.

The ferrite particles are particles which show a ferrite crystal structure by X-ray diffraction analysis. As the ferrite particles, for example, one kind or two or more kinds of ferrite particles having a known composition, such as Ni—Zn ferrite particles, Mn—Zn ferrite particles, and Ni—Cu—Zn ferrite particles, can be used.

An average particle size of the ferrite particles is preferably less than 10.0 µm and more preferably 5.0 µm or less. In addition, the average particle size of the ferrite particles can be, for example, 0.1 µm or more, 0.3 µm or more, or 0.5 µm or more. In one embodiment, from the viewpoint of forming a magnetic layer highly filled with the magnetic particles, it is preferable to use, as the ferrite particles, ferrite particles having an average particle size smaller than that of the metal particles.

### Resin

As the composition for forming a magnetic layer, a magnetic resin composition containing the magnetic particles and a resin can be used. As the resin, a resin having thermosetting properties or photocuring properties is preferable, and a thermosetting resin is more preferable. Examples of the thermosetting resin include various thermosetting resins, such as an epoxy resin, a phenol resin, an acrylic resin, a silicone resin, a urethane resin, a urea resin, and a melamine resin, and from the viewpoint of durability of the formed magnetic layer and adhesiveness to other layers, an epoxy resin is preferable.

Examples of the epoxy resin include various epoxy resins, such as a bisphenol A epoxy resin, a bisphenol F epoxy resin, a bisphenol S epoxy resin, a bisphenol AF epoxy resin, a dicyclopentadiene epoxy resin, a trisphenol epoxy resin, a naphthol novolak epoxy resin, a phenol novolak epoxy resin, a tert-butyl-catechol epoxy resin, a naphthalene epoxy resin, a naphthol epoxy resin, an anthracene epoxy resin, a glycidylamine epoxy resin, a glycidyl ester epoxy resin, a cresol novolak epoxy resin, a biphenyl epoxy resin, a linear aliphatic epoxy resin, an epoxy resin having a butadiene structure, an alicyclic epoxy resin, a heterocyclic epoxy resin, an epoxy resin containing a spiro ring, a cyclohexanedimethanol epoxy resin, a naphthylene ether epoxy resin, and a trimethylol epoxy resin. The epoxy resin may be used alone or in combination of two or more at an arbitrary proportion. A composition containing an epoxy resin can be cured by opening a ring of an epoxy group included in the epoxy resin by heating to form a crosslinking structure. In the magnetic layer formed by curing the composition containing an epoxy resin, a part or all of the epoxy groups included in the epoxy resin can be included in a state in which the ring is opened to form a crosslinking structure.

A content of the resin in the magnetic resin composition is preferably in a range of 1 to 20 parts by mass and more preferably in a range of 3 to 10 parts by mass with respect to 100 parts by mass of the magnetic particles. In addition, in a case where the above-described magnetic resin composition includes two or more kinds of resins, the content of the above-described resin is the total content of these two or more kinds of resins. The same applies to the contents of other components.

### Other Components

The composition for forming a magnetic layer can contain a known additive in an arbitrary amount. Examples of the additive include a component which can function as a curing agent for the thermosetting resin, a component which can function as a dispersing agent for the magnetic particles, a coupling agent, a surfactant, and a thixo agent. Such components are known, and examples thereof include a phenol compound, an amine compound, an imidazole compound, an acid anhydride, and a polymer-based dispersing agent. For example, the thixo agent can exert an action of suppressing sedimentation of the magnetic particles by making the magnetic particles, the resin, and the solvent compatible with each other in the magnetic resin composition. Examples of the thixo agent include a wax-based thixo agent and an amide-based thixo agent. Examples of the wax-based thixo agent include cured castor oil. Examples of the amide-based thixo agent include lauric acid amide, palmitic acid amide, stearic acid amide, behenic acid amide, hydroxystearic acid amide, saturated fatty acid amide, oleic acid amide, erucic acid amide, unsaturated fatty acid amide, p-toluenemethanamide, aromatic amide, methylenebisstearic acid amide, ethylenebislauric acid amide, ethylenebishydroxystearic acid amide, saturated fatty acid bisamide, methylenebisoleic acid amide, unsaturated fatty acid bisamide, m-xylylenebisstearic acid amide, aromatic bisamide, saturated fatty acid polyamide, unsaturated fatty acid polyamide, aromatic polyamide, substituted amide, methylol stearic acid amide, methylol amide, and fatty acid ester amide.

The composition for forming a magnetic layer may be a composition not containing a solvent, and for example, one or more kinds of solvents can also be included to enhance coatability. Examples of the solvent include various organic solvents such as ketone solvents such as acetone, methyl ethyl ketone, and cyclohexanone, acetate solvents such as ethyl acetate, butyl acetate, cellosolve acetate, propylene glycol monomethyl ether acetate, and carbitol acetate, carbitols such as cellosolve and butylcarbitol, aromatic hydrocarbon solvents such as toluene and xylene, and amide solvents such as dimethylformamide, dimethylacetamide, and N-methylpyrrolidone. The solvent can be selected, for example, in consideration of solubility and the like of the components used in the preparation of the composition for forming a magnetic layer. As the solvent, one kind of solvent can be used, or two or more kinds of solvents can be mixed in an arbitrary proportion and used. In a case where the composition for forming a magnetic layer contains a solvent, the solvent can be used in an arbitrary amount in consideration of the coatability and the like of the composition.

The application of the composition for forming a magnetic layer is as described above. With regard to the dispense method which is a preferred coating method, for example, the description of the coating device and the coating method of JP6349480B can be referred to, and specifically, paragraphs 0017, 0018, 0019, 0021, 0028, 0029, 0041, and the like of JP6349480B can be referred to.

In a case where the composition for forming a magnetic layer is a curable composition, the curable composition is cured by subjecting the curable composition to a curing treatment on the applied composition depending on the type of the component contained in the composition, so that the magnetic layer as a cured layer can be formed. The curing treatment conditions may be determined according to the type of the component contained in the composition.

### Conductive Composition

The conductive layer can be formed by applying a conductive composition. In the present invention and the present specification, the “conductive composition” includes a composition containing a conductive component and a composition containing a precursor of the conductive component. Examples of the conductive component include conductive particles such as metal particles and a conductive polymer, and examples of the precursor of the conductive component include a precursor of metal particles. For example, by applying a composition containing conductive particles, a resin, a solvent, and the like and then heating the composition to remove all or a part of the solvent, conductivity can be expressed by the contact of the conductive particles. In addition, by applying a composition containing a precursor of metal particles, a resin, a solvent, and the like and then subjecting the composition to an energy imparting treatment such as light irradiation, conductivity can be expressed by depositing the metal particles. Alternatively, by applying a composition containing conductive particles, a conductive polymer, a solvent, and the like and then heating the composition to remove all or a part of the solvent, conductivity can be expressed by the contact of the conductive components (the conductive particles and/or the conductive polymer). As the conductive composition, a commercially available product can be used, or a composition prepared by a known method can also be used. In a case where the conductive composition is a curable composition, the curable composition is cured by subjecting the curable composition to a curing treatment on the applied composition depending on the type of the component contained in the composition, so that the conductive layer as a cured layer can be formed. The curing treatment conditions may be determined according to the type of the component contained in the composition.

With regard to the above-described manufacturing method of an inductor and the manufactured inductor, other than the points described above, known techniques for the planar inductor can be applied.

### Manufacturing Method of Electronic Component

One aspect of the present invention relates to a manufacturing method of an electronic component including an inductor. In the above-described manufacturing method of an electronic component, an inductor is produced by the above-described manufacturing method of an inductor.

Examples of one aspect of the electronic component including an inductor include a wiring board. With regard to details of the wiring board, paragraphs 0098 to 0155 and FIGS. 1 to 3 of JP2015-187260A can be referred to. The wiring board may further include a semiconductor chip or the like. In addition, various types of semiconductor devices can be manufactured by using such a wiring board. The semiconductor device including such a wiring board can be suitably used for a high-frequency device such as an automobile, a mobile information terminal such as a mobile phone, a flat panel display, a game device, a road information system, and a wireless local area network (LAN).

### EXAMPLES

Hereinafter, the present invention will be described in more detail with reference to Examples. Here, the present invention is not limited to embodiments shown in Examples.

### Example 1

### Preparation of Composition for Forming Magnetic Layer

100 parts by mass of molybdenum permalloy alloy particles (average particle size: 8.1 µm, Ni content: 79.8% by mass, Fe content: 16.2% by mass, Mo content: 3.9% by mass) as metal particles (magnetic particles), 6 parts by mass of an epoxy resin (EXA-4816 manufactured by DIC Corporation), 0.2 parts by mass of an imidazole-type curing agent (jER CURE IBM I12 manufactured by Mitsubishi Chemical Corporation), 0.5 parts by mass of a dispersing agent (DISPERBYK-108 manufactured by BYK Chemie Japan), 0.2 parts by mass of a thixo agent (castor hydrogenated oil A manufactured by Yamakei), and 2 parts by mass of cyclohexanone were charged into a plastic bottle, and a paste-like composition for forming a magnetic layer (hereinafter, also referred to as a “magnetic paste”) was prepared by mixing for 30 minutes with a shaking stirrer, and filled in a syringe container.

### Production of Inductor

A PET film was fixed on a stage of a coating robot (SHOTMASTER 300ΩX manufactured by Musashi Engineering, Inc.), the syringe container filled with the magnetic paste was attached to a syringe holder of the coating robot, and using a dispenser (Super ΣCMIII manufactured by Musashi Engineering, Inc.) and a nozzle with a diameter of 200 µm, at a discharge pressure of 70 kilopascal (kPa), 108 patterns without gaps were formed by continuously discharging the above-described magnetic paste onto a surface of the PET film while the stage was reciprocated 16.2 mm in a X direction at a speed of 3 mm/sec and moved in a Y direction at a feed pitch of 150 µm, thereby forming a first magnetic layer (continuous layer) having an area 16.2 mm × 16.2 mm and a thickness of 215 µm. Here, the X direction and the Y direction are directions set as the X direction and the Y direction in the coating robot. After the formation of the first magnetic layer, the PET film was placed on a hot plate at a set temperature of 90° C. for 1 hour to dry and cure the first magnetic layer.

The above-described magnetic paste was jetted onto the surface of the first magnetic layer in a spiral shape having a width of 500 µm and a thickness of 390 µm to form a second magnetic layer (discontinuous layer).

A conductive paste (CR-2800 manufactured by KAKEN TECH CO., LTD.) was ejected to a discontinuous portion (gap) of the spiral pattern of the second magnetic layer to form a conductive layer in the discontinuous portion. The conductive layer formed as above had a spiral pattern (discontinuous layer) having a width of 1000 µm and a thickness of 200 µm. An outer end part of the spiral of the conductive layer was formed to protrude above the first magnetic layer, and the protruding portion was used as a contact point of the inductor.

After the formation of the conductive layer, the PET film was placed on a hot plate at a set temperature of 90° C. for 1 hour to dry and cure the second magnetic layer and the conductive layer.

The above-described magnetic paste was ejected to fill the groove portion formed by a difference in thickness between the second magnetic layer and the conductive layer, thereby forming a third magnetic layer in the groove portion. The third magnetic layer formed as above had a spiral pattern (discontinuous layer) having a width of 1000 µm and a thickness of 190 µm. The third magnetic layer was not formed on the inner end part of the spiral of the conductive layer, and an exposed portion without being covered with the third magnetic layer was used as a contact point of the inductor.

After the formation of the third magnetic layer, the PET film was placed on a hot plate at a set temperature of 90° C. for 1 hour to dry and cure the third magnetic layer.

With regard to the discharge of the magnetic paste for forming the second magnetic layer, the discharge of the conductive paste for forming the conductive layer, and the discharge of the magnetic paste for forming the third magnetic layer, the PET film was fixed on a stage of a coating robot (SHOTMASTER 300ΩX manufactured by Musashi Engineering, Inc.), the syringe container filled with the magnetic paste was attached to a syringe holder of the coating robot, and using a dispenser (Super ΣCMIII manufactured by Musashi Engineering, Inc.) and a nozzle with a diameter of 200 µm, at a discharge pressure of 70 kPa, a spiral pattern having the shape shown in FIGS. 1A to 1D was formed.

In this way, an inductor (planar inductor) was produced.

### Measurement of Variation in Thickness of Conductive Layer

In a case where a thickness of the PET film was measured at 20 randomly selected locations using a micrometer (Minicomm E-M43RD manufactured by TOKYO SEIMITSU CO., LTD.), and an arithmetic mean of the measured values was obtained, the arithmetic mean was 105 µm.

In the laminate of the PET film and the first magnetic layer after drying and curing the first magnetic layer as described above, in a case where a thickness of the laminate was measured at 20 randomly selected locations using a micrometer (Minicomm E-M43RD manufactured by TOKYO SEIMITSU CO., LTD.), and an arithmetic mean of the measured values was obtained, the arithmetic mean was 320 µm. A value obtained by subtracting the thickness of the PET film obtained above from the obtained value was used as the thickness of the first magnetic layer. The thickness of the first magnetic layer was 215 µm.

In a portion where the PET film, the first magnetic layer, and the conductive layer were laminated after drying and curing the conductive layer as described above, a thickness of the portion was measured at 20 randomly selected locations using a micrometer (Minicomm E-M43RD manufactured by TOKYO SEIMITSU CO., LTD.). The thicknesses of the PET film and the first magnetic layer obtained by the method described above were subtracted from each measured value, and the thickness of the conductive layer at each of the 20 locations was obtained. From the maximum value, the minimum value, and the arithmetic mean of the obtained values, the variation in thickness of the conductive layer was calculated by the following expression.

$$\begin{matrix}\text{Variation in thickness of conductive layer} \left(\text{unit: \%}\right) = \\ \left\{\left(\begin{matrix}\text{Maximum value of thickness of conductive layer -} \\ \text{Minimum value of thickness of conductive layer}\end{matrix}\right) / \begin{matrix}\text{Aritmetic mean of} \\ \text{thicknesses of conductive layer}\end{matrix}\right\} \times 100\end{matrix}$$

Variation in thickness of conductive layer (unit: %) = {(Maximum value of thickness of conductive layer - Minimum value of thickness of conductive layer)/Arithmetic mean of thicknesses of conductive layer} × 100

### Measurement of Variation in Thickness of Inductor

In 20 randomly selected locations of the produced inductor after drying and curing the third magnetic layer, a thickness of the inductor was measured using a micrometer (Minicomm E-M43RD manufactured by TOKYO SEIMITSU CO., LTD.). From the maximum value, the minimum value, and the arithmetic mean of the measured values, the variation in thickness of the inductor was calculated by the following expression.

$$\begin{matrix}\text{Variation in thickness of inductor} \left(\text{unit:} \%\right) = \\ \left\{\left(\begin{matrix}\text{Maximum value of thickness of inductor -} \\ \text{Minimum value of thickness of inductor}\end{matrix}\right) / \begin{matrix}\text{Arithmetic mean of} \\ \text{thicknesses of inductor}\end{matrix}\right\} \times 100\end{matrix}$$

### Measurement of Inductance

Using an LCR meter IM3536 manufactured by HIOKI E.E. CORPORATION, a probe was applied to two contact points of the inductor in Example 1 to measure inductance (unit: µH (microhenry)) at 8 MHz (megahertz).

### Example 2

The first magnetic layer was formed in the same manner as in Example 1.

A conductive paste (CR-2800 manufactured by KAKEN TECH CO., LTD.) was jetted onto the surface of the first magnetic layer in a spiral shape having a width of 1000 µm and a thickness of 200 µm to form a conductive layer (discontinuous layer). An outer end part of the spiral of the conductive layer was formed to protrude above the first magnetic layer, and the protruding portion was used as a contact point of the inductor.

The same magnetic paste as in Example 1 was ejected to a discontinuous portion (gap) of the spiral pattern of the conductive layer to form a second magnetic layer in the discontinuous portion. The second magnetic layer formed as above had a spiral pattern (discontinuous layer) having a width of 500 µm and a thickness of 390 µm.

After the formation of the second magnetic layer, the PET film was placed on a hot plate at a set temperature of 90° C. for 1 hour to dry and cure the conductive layer and the second magnetic layer.

The same magnetic paste as in Example 1 was ejected to fill the groove portion formed by a difference in thickness between the second magnetic layer and the conductive layer, thereby forming a third magnetic layer in the groove portion. The third magnetic layer formed as above had a spiral pattern (discontinuous layer) having a width of 1000 µm and a thickness of 190 µm. The third magnetic layer was not formed on the inner end part of the spiral of the conductive layer, and an exposed portion without being covered with the third magnetic layer was used as a contact point of the inductor.

After the formation of the third magnetic layer, the PET film was placed on a hot plate at a set temperature of 90° C. for 1 hour to dry and cure the third magnetic layer.

With regard to the discharge of the magnetic paste for forming the conductive layer, the discharge of the conductive paste for forming the second magnetic layer, and the discharge of the magnetic paste for forming the third magnetic layer, the PET film was fixed on a stage of a coating robot (SHOTMASTER 300ΩX manufactured by Musashi Engineering, Inc.), the syringe container filled with the magnetic paste was attached to a syringe holder of the coating robot, and using a dispenser (Super ΣCMIII manufactured by Musashi Engineering, Inc.) and a nozzle with a diameter of 200 µm, at a discharge pressure of 70 kPa, a spiral pattern having the shape shown in FIGS. 1A to 1D was formed.

In this way, an inductor (planar inductor) was produced.

Various measurements were carried out on the inductor of Example 2 in the same manner as in Example 1.

### Comparative Example 1

The first magnetic layer and the conductive layer (discontinuous layer having a spiral pattern) were formed in the same manner as in Example 2.

Thereafter, using the same coating robot and dispenser as in Example 1 and a nozzle with a diameter of 200 µm, at a discharge pressure of 140 kPa, 108 patterns were formed by continuously discharging the same magnetic paste as in Example 1 while the stage was reciprocated 16.2 mm in a X direction at a speed of 2 mm/sec and moved in a Y direction at a feed pitch of 150 µm, to cover the first magnetic layer and the conductive layer, thereby forming a second magnetic layer (continuous layer) having an area 16.2 mm × 16.2 mm. In this way, the upper surface and the side surfaces of the pattern of the conductive layer were collectively covered with the second magnetic layer.

After the formation of the second magnetic layer, the PET film was placed on a hot plate at a set temperature of 90° C. for 1 hour to dry and cure the second magnetic layer.

Various measurements were carried out on the inductor of Comparative Example 1 in the same manner as in Example 1.

The above results are shown in Table 1.

TABLE 1

| | Variation in thickness of conductive layer [%] | Variation in thickness of inductor [%] | Inductance [µH] |
|---|---|---|---|
| Example 1 | 11 | 12 | 0.60 |
| Example 2 | 19 | 13 | 0.58 |
| Comparative Example 1 | 19 | 29 | 0.48 |

The inductor of Example 1 and the inductor of Example 2 exhibited higher inductance as compared with the inductor of Comparative Example 1.

In addition, from the comparison between Example 1 and Example 2, it can be confirmed that forming the discontinuous layer of the conductive layer after forming the discontinuous layer of the second magnetic layer is preferable from the viewpoint of reducing the variation in thickness of the conductive layer.

One embodiment of the present invention is useful in the technical field of various electronic components.

What is claimed is:

1. A manufacturing method of an inductor, comprising:
forming a first magnetic layer; and
forming a discontinuous layer of one of a second magnetic layer and a conductive layer on the first magnetic layer, and forming the other in a discontinuous portion of the discontinuous layer,
wherein a thickness of the second magnetic layer is larger than a thickness of the conductive layer, and
the manufacturing method further includes forming a third magnetic layer in a groove portion formed by a difference in thickness between the second magnetic layer and the conductive layer.

2. The manufacturing method of an inductor according to claim 1,
wherein, in the forming a discontinuous layer of one of a second magnetic layer and a conductive layer on the first magnetic layer, and forming the other in a discontinuous portion of the discontinuous layer,
a discontinuous layer of the second magnetic layer is formed on the first magnetic layer, and the conductive layer is formed in a discontinuous portion of the discontinuous layer of the second magnetic layer.

3. The manufacturing method of an inductor according to claim 1,
wherein the discontinuous layer has a spiral pattern.

4. The manufacturing method of an inductor according to claim 2,
wherein the discontinuous layer has a spiral pattern.

5. The manufacturing method of an inductor according to claim 1,
wherein the forming of the second magnetic layer and the forming of the third magnetic layer are performed by applying a composition containing magnetic particles.

6. The manufacturing method of an inductor according to claim 2,
wherein the forming of the second magnetic layer and the forming of the third magnetic layer are performed by applying a composition containing magnetic particles.

7. The manufacturing method of an inductor according to claim 3,
wherein the forming of the second magnetic layer and the forming of the third magnetic layer are performed by applying a composition containing magnetic particles.

8. The manufacturing method of an inductor according to claim 4,
wherein the forming of the second magnetic layer and the forming of the third magnetic layer are performed by applying a composition containing magnetic particles.

9. The manufacturing method of an inductor according to claim 5,
wherein the applying of the composition containing magnetic particles is performed by applying the composition containing magnetic particles with a dispenser.

10. The manufacturing method of an inductor according to claim 5,
wherein the composition containing magnetic particles is a magnetic resin composition containing the magnetic particles and a resin.

11. The manufacturing method of an inductor according to claim 5,
wherein the magnetic particles are metal particles.

12. The manufacturing method of an inductor according to claim 11,
wherein the metal particles include Ni and Fe.

13. The manufacturing method of an inductor according to claim 12,
wherein the metal particles further include Mo.

14. The manufacturing method of an inductor according to claim 1,
wherein the forming of the conductive layer is performed by applying a conductive composition.

15. The manufacturing method of an inductor according to claim 14,
wherein the applying of the conductive composition is performed by applying the conductive composition with a dispenser.

16. A manufacturing method of an electronic component including an inductor, the manufacturing method comprising:
producing an inductor by the manufacturing method according to claim 1.
